(19) United States
(12) Patent Application Publication
(10) Pub. No.: US 2012/0096354 A1
(43) Pub. Date: Apr. 19, 2012

(54) MOBILE TERMINAL AND CONTROL METHOD THEREOF

(76) Inventors: Seungyong Park, Seoul (KR); Dami Choe, Seoul (KR)

(21) Appl. No.: 12/988,969

(22) PCT Filed: Oct. 14, 2010
(86) PCT No.: PCT/KR10/07062

§ 371 Date: Oct. 21, 2010

(51) Int. Cl. G06F 3/048

(52) U.S. Cl. 715/719; 715/764; 715/769

(57) ABSTRACT

A mobile terminal and a control method thereof are disclosed. A mobile terminal and a control method thereof comprise a display; and a controller, when receiving a selection signal for a first item displayed on the display, searching for at least one second item of the same attribute with the first item selected and displaying the second item. According to the present invention, a search for related information is made easy by searching for a second item of the same attribute with that of a first item selected and displaying the second item.

This application claims the benefit of PCT Application No. PCT/KR2010/007062 filed on Oct. 14, 2010 which are hereby incorporated by reference.

### BACKGROUND

1. Field

This document relates to a mobile terminal and a control method thereof. More specifically, this document relates to a mobile terminal and a control method thereof by which a search for related information is made easy by searching for a second item of the same attribute with that of a first item selected and displaying the second item.

2. Related Art

As the functions of terminals such as personal computers, laptop computers, cellular phones and the like are diversified, the terminals are constructed in the form of a multimedia player having multiple functions of capturing pictures or moving images, playing music, moving image files and games and receiving broadcasting programs.

Terminals can be divided into mobile terminals and stationary terminals. The mobile terminals can be classified into handheld terminals and vehicle mount terminals according to whether users can personally carry the terminals.

To support and enhance functions of a terminal, improving a structural part and/or a software part of the terminal is being considered.

As a variety of recent terminals including mobile terminals provide more complex and various functions, a menu structure is also becoming complex. Moreover, a function for displaying various digital documents including web pages is being added.

### DISCLOSURE

### Technical Problem

This document relates to a mobile terminal and a control method thereof by which a search for related information is made easy by searching for a second item of the same attribute with a first item selected and displaying the second item.

### Technical Solution

To achieve the above advantage, a mobile terminal according to one embodiment of the present invention comprises a display; and a controller, when receiving a selection signal for a first item displayed on the display, searching for at least one second item of the same attribute with the first item selected and displaying the second item.

The display comprises a first area displaying the at least one first item and a second area generating the selection signal in accordance with a touch motion to drag and drop a first item displayed in the first area.

The first item and the second item comprise at least one of an image, a video, an e-mail, a text message, and a social network service message stored in the mobile terminal.

The first item and the second item comprise at least one of an image, a video, an e-mail, a message, and a social network service message stored either in a different terminal or an external server.

The attribute comprises a first attribute comprising a category to which the first and the second item belong; and a second attribute comprising at least one of time at which the first and the second item have been created, a transmitter of the first and the second item, a receiver of the first and the second item, contents of the first and the second item, and titles of the first and the second item.

The controller, within a category whose first attribute is the same as the first attribute of the first item selected, searches for a second item whose second attribute is the same as that of the first item selected and displays the second item.

The attribute can be tag information included in the first and the second item.

The controller, if the number of first items which have received the selection signal is more than one, can search for the second item on the basis of an attribute common in the plurality of first items and display the second item.

Meanwhile, to achieve the above advantage, a mobile terminal according to one embodiment of the present invention comprises a display; and a controller, when receiving a touch signal to drag and drop a first item displayed in a first area of the display to a second area of the display, searching for a second item of the same attribute with the first item dragged and dropped and displaying the second item.

The first and the second item comprise an image, a video, an e-mail, a text message, and a social network service message stored in any one of the mobile terminal, a different terminal, and an external server.

The attribute comprises a first attribute comprising a category to which the first and the second item belong; and a second attribute comprising at least one of time at which the first and the second item have been created, a transmitter of the first and the second item, a receiver of the first and the second item, contents of the first and the second item, and titles of the first and the second item.

The controller, within a category whose first attribute is the same as the first attribute of the first item selected, searches for a second item whose second attribute is the same as that of the first item selected and displays the second item.

Moreover, to achieve the above advantage, a control method for a mobile terminal according to one embodiment of the present invention comprises displaying a first item; receiving a selection signal for at least one of the first items; and searching for and displaying at least one second item of the same attribute with the selected at least one first item.

The receiving the selection signal comprises dragging the displayed first item; dropping the dragged first item into a predetermined area; and generating the selection signal in accordance with the first item dropped into the predetermined area.

The first and the second item comprise at least one of an image, a video, an e-mail, a message, and a social network service message stored in any one of the mobile terminal, a different terminal, and an external server.

The searching and displaying, among second items corresponding to the attribute of a category to which the first items belong, displays a second item corresponding to any one of time at which the first item has been created, a transmitter of the first item, a receiver of the first item, contents of the first item, and a title of the first item.

### Advantageous Effects

A mobile terminal and a control method thereof make a search for related information convenient by searching for a second item of the same attribute with that of a selected first item and displaying the second item.

### BRIEF DESCRIPTION OF THE DRAWINGS

The accompanying drawings, which are included to provide a further understanding of this document and are incorporated to constitute a part of this specification, illustrate embodiments of this document and together with the description serve to explain the principles of this document.

FIG. 1 is a block diagram of a mobile terminal according to one embodiment of the present invention;

FIG. 2 is a flow chart illustrating operation of a mobile terminal of FIG. 1;

FIGS. 3 to 6 illustrate operation of a mobile terminal of FIG. 2;

FIG. 7 illustrates another operation of a mobile terminal of FIG. 2;

FIG. 8 illustrates attributes according to the respective items;

FIG. 9 illustrates a search result of a mobile terminal of FIG. 2 in the form of a tree;

FIG. 10 illustrates a search target of a mobile terminal of FIG. 2;

FIG. 11 illustrates operation of a mobile terminal according to another embodiment of the present invention;

FIGS. 12 and 13 illustrate operation of a mobile terminal according to still another embodiment of the present invention; and

FIG. 14 illustrates operation of a mobile terminal according to a further embodiment of the present invention.

### DETAILED DESCRIPTION

The above purpose, characteristics, and advantages of the present invention will now be described more fully with reference to the accompanying drawings. The invention may, however, be embodied in many different forms and in what follows, particular embodiments of the invention are illustrated in the accompanying drawings and described in detail. Basically, the same reference numbers across the document represent the same constituting elements. In addition, if it is determined that disclosure related to the invention or a specific description about structure of the invention may lead to misunderstanding of the purpose of the invention, the corresponding specific description would be omitted. Also, numerals employed for description of the invention (e.g., a first, a second, etc.) are introduced only to distinguish a constituting element from the other ones.

Hereinafter, a mobile terminal related to the present invention will be described below in more detail with reference to the accompanying drawings. In the following description, suffixes “module” and “unit” are used only in consideration of facilitating description and do not have meanings or functions discriminated from each other.

A mobile terminal described in the document can include a cellular phone, a smart phone, a laptop computer, a digital broadcasting terminal, a personal digital assistant (PDA), a portable multimedia player (PMP), a navigation system, and so on. Except for the cases applicable only to a mobile terminal, those skilled in the art will easily understand that the structure according to embodiments described in this document can also be applied to fixed terminals such as a digital TV, a desktop computer, and so on.

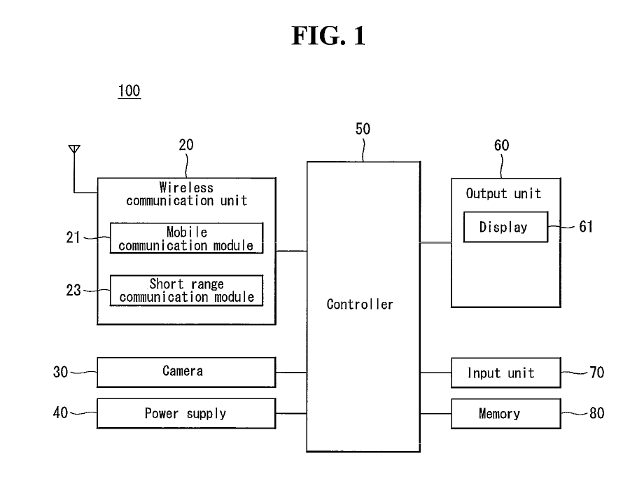

FIG. 1 is a block diagram of a mobile terminal according to one embodiment of the present invention.

A mobile terminal 100 can comprise a wireless communication unit 20, a camera 30, a memory 80, a controller 50, an output unit 60, and an input unit 70.

A wireless communication unit 20 can comprise more than one module which enables wireless communication between a mobile terminal 100 and a wireless communication system or between a mobile terminal 100 and a network in which the mobile terminal 100 is positioned. For example, the wireless communication unit 20 can comprise a mobile communication module 21 and a short range communication module 23; and although not illustrated fully in the figure, further comprise a wireless Internet module and a location information module.

A mobile communication module 21 transmits and receives radio signals to and from at least one of a base station, an external terminal, and a server, all belonging to a mobile communication network. Radio signal can comprise various types of data depending on a voice call signal, a video communication call signal, or text/multimedia message communication.

A short range communication module 23 is a module for short range communication. Bluetooth, radio frequency identification (RFID), infrared data association (IrDA), ultra wideband (UWB), or ZigBee can be used to implement short range communication.

A camera 30 processes a video frame comprising a still image or a video obtained by an image sensor at a video communication mode or a shooting mode, respectively. A processed video frame can be displayed on an output unit 60. A video frame processed by the camera 30 can be stored in a memory or transmitted to the outside through the wireless communication unit 20. More than one camera can be employed according to the structural aspect of a terminal: for example, a first camera installed in the front of the mobile terminal 100 and a second camera installed in the rear of the mobile terminal 100. The first camera can be used for shooting the user of the mobile terminal 100 during video communication while the second camera for shooting external scenes.

A power supply 40 can make use of an external and an internal power source controlled by a controller 50; and provide power required for the operation of individual constituting elements.

A controller 50 controls the overall operation of a mobile terminal 100. For example, the controller 50 performs control and processing related to voice communication, data communication, video communication, and the like. The controller 50 can be equipped with a multimedia module for playing multimedia. A multimedia module can be implemented inside the controller 50 or separately from the controller 50. The controller 50 can perform a pattern recognition process by which a hand writing input and a drawing input on the touch screen can be recognized as characters and images, respectively.

An output unit 60 can display a variety of information comprising the status of the mobile terminal 100 and the like in various ways. In other words, FIG. 1 illustrates a display 61 as an output unit 60, which actually implies that the output unit 60 can include a voice output module, a haptic module, and so on.

An input unit 70 can comprise a plurality of key buttons manipulated to receive commands for controlling operation of a mobile terminal 100. Key buttons can be called a manipulating portion and any kind of a method can be employed if the method supports a tactile manner by which the user manipulates key buttons while feeling tactile sense. Contents input by key buttons can be set in various ways. Meanwhile, the display 61 illustrated to belong to the output unit 60 can also function as the input unit 70. For example, if the display 61 is composed of a touch screen, a touch motion that the user applies to the display 61 can be obtained as an input to the mobile terminal 100.

A memory 80 can store a program for the operation of the controller 50 and temporarily store input/output data (e.g., phone book, message, still image, video, etc.). The memory 80 can store various patterns of vibrations and sounds produced when a touch input is sensed from the touch screen. The memory 80 can comprise at least one of a flash memory type, a hard disk type, a multimedia card micro type, a card type memory (e.g., SD or XD memory), RAM (Random Access Memory), SRAM (Static Random Access Memory), ROM (Read Only Memory), EEPROM (Electrically Erasable Programmable Read Only Memory), PROM (Programmable Read Only Memory), a magnetic memory, a magnetic disk, and an optical disk. A mobile terminal 100 can operate in association with a web storage which performs a storage function of the memory on the Internet.

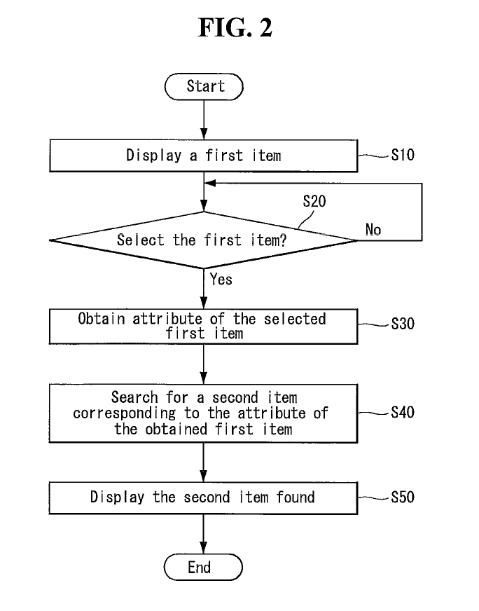

FIG. 2 is a flow chart illustrating operation of a mobile terminal of FIG. 1 and FIGS. 3 to 6 illustrate operation of a mobile terminal of FIG. 2.

As shown in the figures, a controller (50 of FIG. 1) of a mobile terminal 100 according to one embodiment of the present invention can be made to carry out displaying S10 a first item (M).

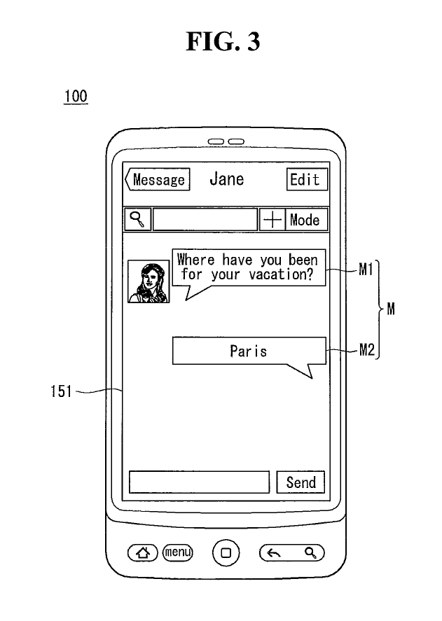

A first item (M) can be an object or contents which the user selects to search for related information. The first item (M) can be created by the user or obtained from the outside. For example, the first item (M) can be any one of a photograph taken, an e-mail exchanged with another person, a text message exchanged with another person, and a music file. In other words, the first item includes all kinds of contents that can be created or obtained in association with the use of the mobile terminal 100. FIG. 3 illustrates a message as the first item (M), which the user of the mobile terminal 100 exchanges with another person. As shown in the figure, the controller (50 of FIG. 1) can display messages exchanged with another person on the display 151 in a sequential order.

Determining S20 whether the first item (M) displayed has been selected can be performed.

Part of the first item (M) can be selected by a control signal of the controller (50 of FIG. 1) or the user's selection, which will be described in more detail below.

The controller (50 of FIG. 1) can determine that a particular first item (M) has been selected once a particular event occurs. For example, if a message exchanged with another person contains contents in which the user of the mobile terminal 100 might get interested, the controller (50 of FIG. 1) can set the first item (M) containing the contents as selected. According to FIG. 3, if a word of ‘Paris’ is contained and it is determined that the user would get interested in the word, the controller (50 of FIG. 1) can determine that the word has been selected.

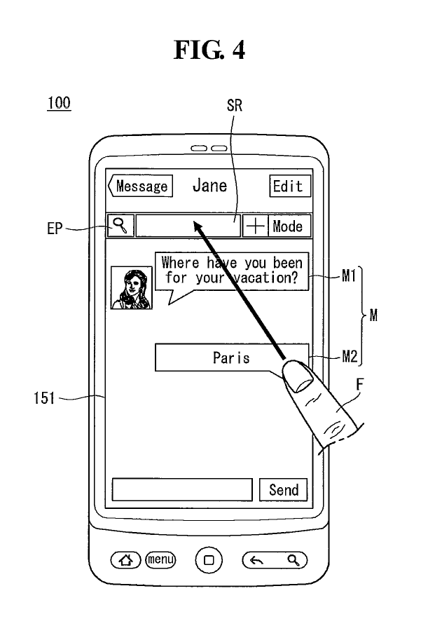

Selection of part of the first item (M) selected by the user can be carried out by a touch input of the user. For example, as shown in FIG. 4, the user can drag a particular one among the first items (M) by using his or her finger (F) and drop the particular one into a search window (SR). In other words, during conversation with another person, if the user wants to search for ‘Paris’ more specifically, the first item (M) can be dragged and dropped into the search window (SR).

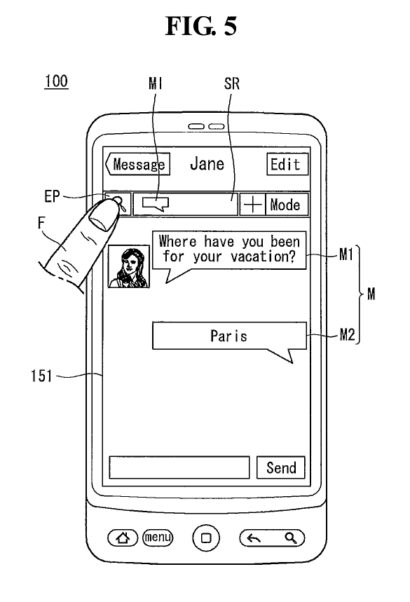

If the first item (M) is dragged and dropped into the search window (SR), an icon (MI) is displayed in the search window (SR). The icon (MI) can be varied according to the first item (M). For example, as shown in FIG. 5, if the first item (M) is a text message, an icon in the form of a speech balloon can be displayed. The user, after drag and drop of the first item (M), touches a search button (EP) and can initiate the next step for a search based on the selected first item (M).

If at least one of the first items (M) is selected, obtaining S30 the attribute of the selected first item (M) can be started.

The attribute of a first item (M) can comprise a first attribute and a second attribute. The first attribute can be a category to which the first item (M) belongs. For example, the first attribute can be information to determine whether the first item (M) corresponds to a text message, a photograph, a video, an e-mail, an SNS message, or a music file.

The second attribute can be the contents itself of the first item and related to creation thereof. For example, as shown in FIG. 4, if the selected first item (M) is a text message, the corresponding attribute can be a text message category, contents of the text message, the person who exchanged the text message, creation time of the text message, and the like. Detailed description of the attribute will be provided more specifically in the corresponding part of this document.

If the attribute of the selected first item (M) is obtained, searching S40 for a second item (N) corresponding to the obtained attribute of the first item (M) and displaying S50 the second item (N) found can be carried out.

The second item (N) can be an item of the same attribute with the first item (M). In other words, the second item (N) can be the contents searched for based on the selected first item (M). A search for the second item (N) can be performed for the contents already stored in the memory (80 of FIG. 1) of the mobile terminal 100 or for an external terminal or a server.

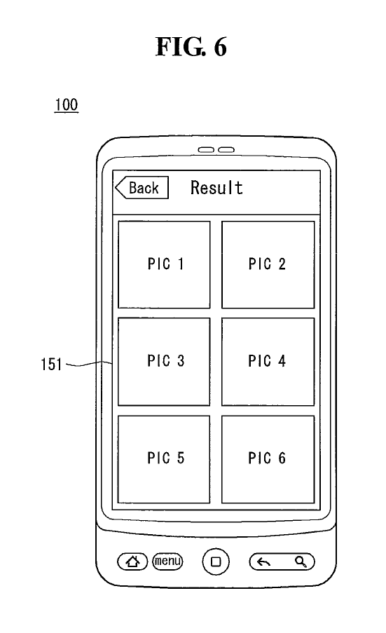

The second item (N) found, as shown in FIG. 6, can be displayed in the display 151. The second item (N) displayed can be of the same attribute with that of the selected first item (M). For example, if the first item (M) is a text message about ‘Paris’, the second item (N) displayed can be various images related to ‘Paris’. In other words, the second item (N) displayed can be a photograph of the place that the user of the mobile terminal 100 has actually taken or an image downloaded from the user of another terminal. Meanwhile, pictures (PIC1 to PIC6) displayed in FIG. 6 are represented by texts, which has been made in that way only for the convenience of description. In other words, pictures (PIC1 to PIC6) can be represented by actual images.

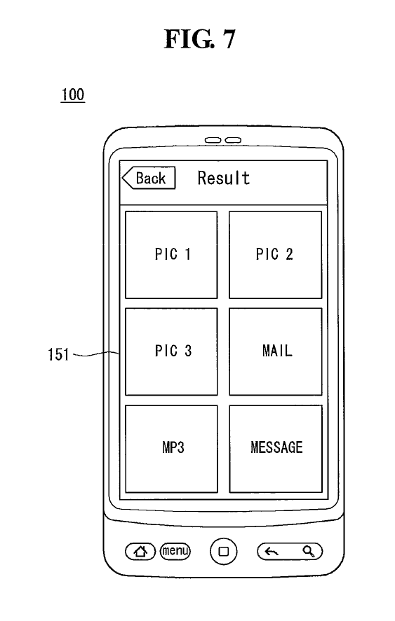

FIG. 7 illustrates another operation of a mobile terminal of FIG. 2.

As shown in the figure, a mobile terminal 100 according to another operation of the present invention can display a second item N belonging to various categories.

For the controller (50 of FIG. 1) searching for the second item (N), a search target may not be specified by a particular category. In other words, items belonging to various categories such as a picture (PIC1, PIC2, PIC3), an e-mail (MAIL), a music file (MP3), a text message (MESSAGE), and the like can be displayed. For example, if the selected first item (M) is ‘Paris’, photographs (PIC1 to PIC3) taken by the user of the mobile terminal 100 in the corresponding place, an e-mail (MAIL) transmitted by the user of the mobile terminal 100 in the corresponding place, music files (MP3) related to the corresponding place, and a text message transmitted by the user of the mobile terminal 100 in the corresponding place can be searched for and displayed. The user or the controller (50 of FIG. 1) can properly set the range of the second item (N) to be searched for and/or displayed. For example, various cases can be implemented that a search can be carried out within only the items belonging to the same category or within those belonging to several categories selected.

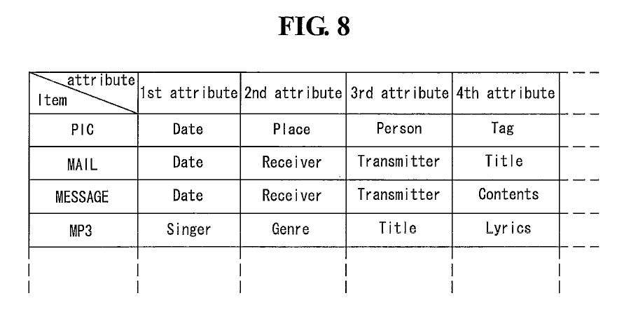

FIG. 8 illustrates attributes according to the respective items.

As shown in the figure, attributes can be varied according to the types of the items. Also, a single item can have multiple attributes.

In case of an image item (PIC), a first attribute can be information about the date when the image has been created. For example, the first attribute can be the date when the photograph has been taken or the date when the photograph has been downloaded. A second attribute of the image item (PIC) can be information about a place. For example, the second attribute can be the place where the photograph has been taken. A third attribute of the image item (PIC) can be information about a person. For example, the third attribute can be information about a person in the photograph. Information about a person in a photograph can be automatically generated by the controller (50 of FIG. 1) by using a face recognition method. A fourth attribute of the image item (PIC) can be tag information. In other words, the fourth attribute can be information specially added, although the information does not fall into any one of the first to the third attribute. For example, the fourth attribute can be a memo which the user has added to a particular photograph. Also, additional attributes can exist, if required.

In case of an e-mail item (MAIL), the first attribute can be information about the date the e-mail has been exchanged; the second and the third attribute can be a receiver and a sender, respectively. Also, the fourth attribute can be the title of the e-mail.

In case of a message item (MESSAGE), the contents of the message item can be included as the fourth attribute.

In case of a music file item (MP3), a singer's name can be the first attribute; a genre the second attribute; a title the third attribute; and lyrics the fourth attribute.

The controller (50 of FIG. 1), based on the inherent attribute information of each item, can search the items expected to contain the same contents. For example, if the place, the second attribute of the image item (PIC), is ‘Paris’, a title which is the fourth attribute of the e-mail item (MAIL), contents which is the fourth attribute of the message item (MESSAGE); and a title and lyrics which are the third and the fourth attribute of the music file item (MP3) are searched to determine whether ‘Paris’ is contained in the respective attributes.

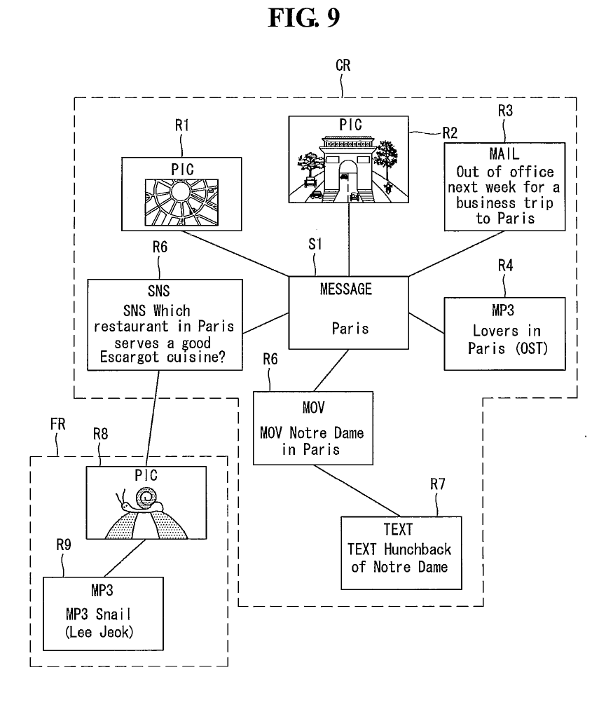

FIG. 9 illustrates a search result of a mobile terminal of FIG. 2 in the form of a tree.

As shown in the figure, a search result of the controller (50 of FIG. 1) can be represented by relationship in the form of a tree.

If a seed keyword S1 extracted from the first item is ‘Paris’, a first result (R1) can be a map image of Paris; a second result (R2) Arc de Triomphe in Paris; a third result (R3) an e-mail notifying of a business trip to Paris; a fourth result (R4) a song whose title includes Paris; a fifth result (R5) a movie about Paris; a seventh result (R7) derived from the fifth result (R5) a text related to ‘Notre Dame’ of the fifth result (R5); a sixth result (R6) a text of a social network service about restaurants in Paris; an eighth result (R8) derived from the sixth result (R6) an image related to a ‘snail’ of the sixth result (R6); and a ninth result (R9) derived from the eighth result (R8) a song related to the ‘snail’ of the eighth result (R8).

The first to the sixth result (R1 to R6) can be those related directly to the seed keyword (S1). The controller (50 of FIG. 1) can determine whether a result is directly related to the seed keyword (S1) based on how many attributes of the seed keyword (S1) match the attributes of the first to the sixth result (R1 to R6). The first to the sixth result (R1 to R6) have a high chance of not containing attributes corresponding to the seed keyword (S1) except for the place name itself. Although the seventh result (R7) does not contain ‘Paris’ itself in the title, either, as ‘Paris’ is contained in the contents of the text, similarity can be relatively high. Therefore, the controller (50 of FIG. 1), considering the first to the seventh result (R1 to R7) as display results (CR), can display the results on the display 151.

The eighth and the ninth result (R8, R9) derived from the ‘snail’ of the sixth result can be evaluated to have relatively low relationship with the seed keyword (S1). Therefore, the controller (50 of FIG. 1), considering the eighth and the ninth result (R8, R9) as error information (FR), may not display the results on the display 151.

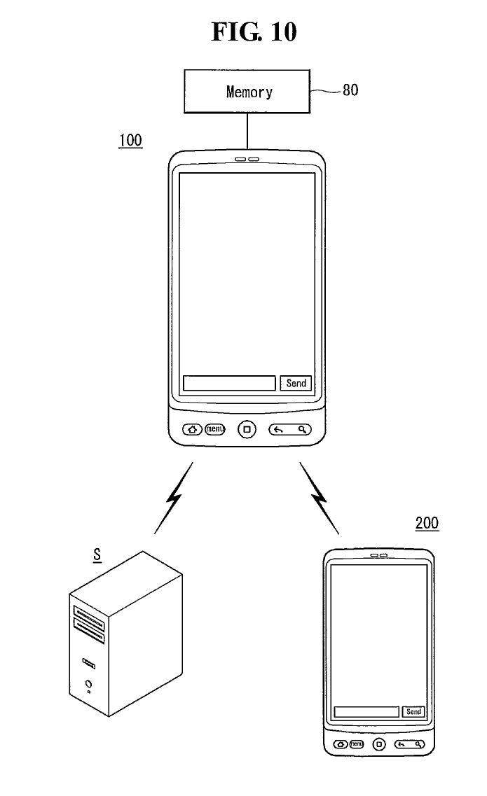

FIG. 10 illustrates a search target of a mobile terminal of FIG. 2.

As shown in the figure, a mobile terminal 100 according to one embodiment of the present invention can have various search targets for an item.

The mobile terminal 100 can search the data stored in the memory 80 included in the mobile terminal 100 for an item. For example, the controller (50 of FIG. 1) can determine whether an attribute matches or not by consulting a photograph stored in the memory 80.

The mobile terminal 100 can search a server (S) outside of the mobile terminal 100 and/or data stored in a different terminal 200 for an item. For example, the controller (50 of FIG. 1) can transmit a seed keyword (S1 of FIG. 9) to an external server (S) and/or a different terminal 200. The external server (S) and/or the different terminal 200 perform a search based on the seed keyword (S1 of FIG. 9) received and transmits the search result to the mobile terminal 100. The mobile terminal 100 can communicate with the external server (S) and/or the different terminal 200 through a mobile communication module (21 of FIG. 1) and/or a short range communication module (23 of FIG. 1).

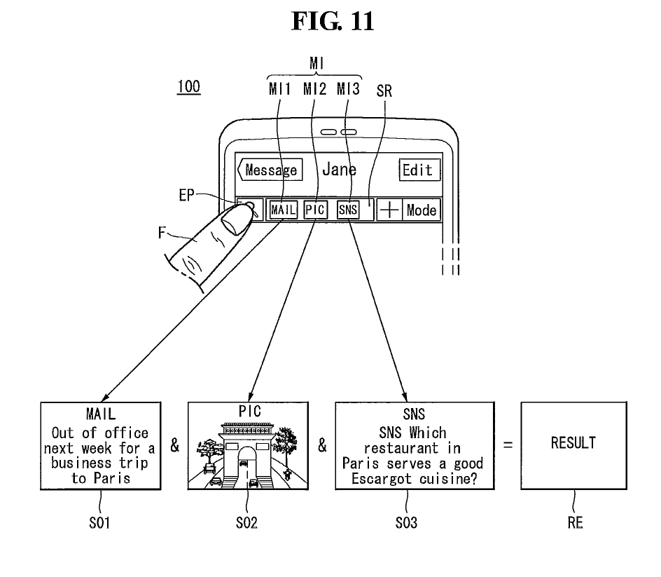

FIG. 11 illustrates operation of a mobile terminal according to another embodiment of the present invention.

As shown in the figure, a mobile terminal 100 according to another embodiment of the present invention can perform a search based on a combination of a plurality of seed keywords (MI).

The user can drag items and drop the items in a search window (SR). For example, a first, a second, and a third item (MI1, MI2, MI3) can be dropped in the search window (SR). Items dropped in the search window (SR) can be those which the user intended to search for related contents. The first, the second, and the second item (MI1, MI2, M13) can fall into the same category or belong to the respective categories. When drag and drop of items into the search window (SR) is completed, the user can touch a search button (EP).

If the search button (EP) is touched, a search based on the first, the second, and the third item (MI1, MI2, MI3) moved to the search window (SR) can be performed. At this time, items moved to the search window can generate a search equation by combination of the items. For example, if the first item (MI1) is an e-mail item (S01) related to Paris tour; the second item (MI2) an image item (S02) photographing Arc de Triomphe in Paris; and the third item (MI3) a text uploaded to a social network service about restaurants in Paris, the controller (50 of FIG. 1) can extract a search result (RE) based on common facts among the three items. In other words, a seed keyword can be generated through and-operation or or-operation of the attributes of the three items; and a search result (RE) can be extracted based on the seed keyword.

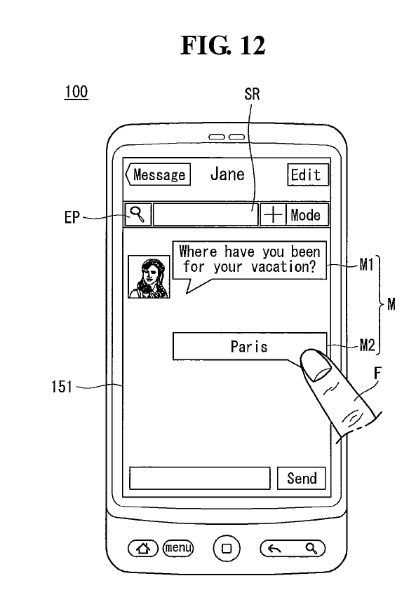

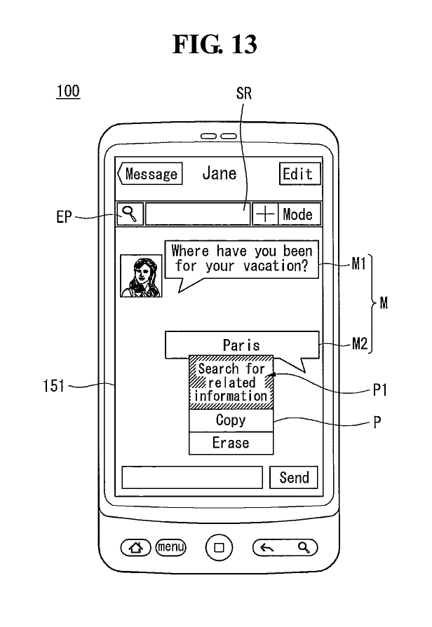

FIGS. 12 and 13 illustrate operation of a mobile terminal according to still another embodiment of the present invention.

As shown in the figure, a mobile terminal according to still another embodiment of the present invention can select a search target in various ways.

As shown in FIG. 12, the user can select a first item (M) by using his or her finger (F). For example, the user can select one of the first items (M) by long touching. FIG. 12 illustrates an SMS message as the first item (M); as described above, however, a photograph, an e-mail exchanged with another person, a music file, and the like can also be taken as the first item (M).

As shown in FIG. 13, if any one of the first items (M) is selected, a pop-up window (P) can be displayed. The pop-up window (P) can display a menu related to the selected first item (M). For example, the pop-up window (P) can display a menu for copying or erasing the contents of the selected first item (M). Moreover, the pop-up window (P) can display a menu (P1) for searching for related information.

The menu (P1) for searching for related information can be a menu which performs a function of searching for contents related to the selected first item (M). In other words, as described with reference to FIG. 4, besides a method of dragging and dropping the first item (M) into the search window (SP) to select the first item (M), long touching of the first item (M) can also activate a search for the related contents.

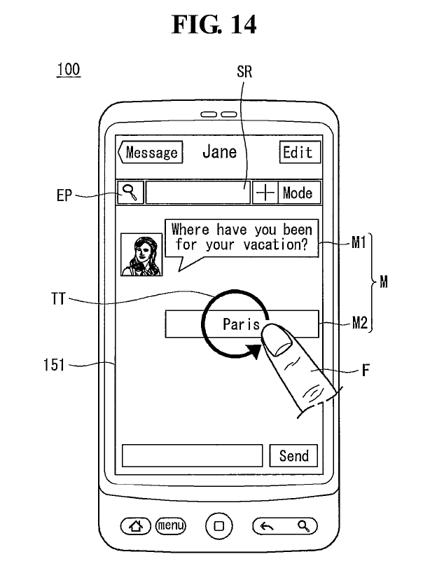

FIG. 14 illustrates operation of a mobile terminal according to a further embodiment of the present invention.

As shown in the figure, the user can select a first item (M) by doing a particular gesture (TT).

The user can do a gesture (TT) for a particular one among the first items (M) by using his or her finger (F). For example, the user can do a gesture (TT) surrounding a periphery of a word to be searched. If the user performs a gesture (TT) drawing a looped curve selecting a particular word, the controller (50 of FIG. 1), based on the selected word, can search for related contents.

The embodiments above assume that an item is moved to a search window in the first place and a search is then performed by touching a search button. However, it should be understood that starting a search as soon as an item is moved to the search window is equally possible.

The present invention is not limited to a number of illustrative embodiments above and it should be apparent to those skilled in the art that numerous other modifications and variations can be devised without departing from the spirit and scope of the principles of this disclosure.

Therefore, it should be understood that those modifications or variations belong to the scope of the appended claims of the present invention.

What is claimed is:

1. A mobile terminal, comprising:
a display; and
a controller, when receiving a selection signal for a first item displayed on the display, searching for at least one second item of the same attribute with the first item selected and displaying the second item.

2. The mobile terminal of claim 1, wherein the display comprises a first area displaying the at least one first item and a second area generating the selection signal in accordance with a touch motion to drag and drop a first item displayed in the first area.

3. The mobile terminal of claim 1, wherein the first item and the second item comprise at least one of an image, a video, an e-mail, a text message, and a social network service message stored in the mobile terminal.

4. The mobile terminal of claim 1, wherein the first item and the second item comprise at least one of an image, a video, an e-mail, a message, and a social network service message stored either in a different terminal or an external server.

5. The mobile terminal of claim 1, wherein the attribute comprises a first attribute comprising a category to which the first and the second item belong; and a second attribute comprising at least one of time at which the first and the second item have been created, a transmitter of the first and the second item, a receiver of the first and the second item, contents of the first and the second item, and titles of the first and the second item.

6. The mobile terminal of claim 5, wherein the controller, within a category whose first attribute is the same as the first attribute of the first item selected, searches for a second item whose second attribute is the same as that of the first item selected and displays the second item.

7. The mobile terminal of claim 1, wherein the attribute is tag information included in the first and the second item.

8. The mobile terminal of claim 1, wherein the controller, if the number of first items which have received the selection signal is more than one, searches for the second item on the basis of an attribute common in the plurality of first items and displays the second item.

9. A mobile terminal, comprising:
a display; and
a controller, when receiving a touch signal to drag and drop a first item displayed in a first area of the display to a second area of the display, searching for a second item of the same attribute with the first item dragged and dropped and displaying the second item.

10. The mobile terminal of claim 9, wherein the first and the second item comprise an image, a video, an e-mail, a text message, and a social network service message stored in any one of the mobile terminal, a different terminal, and an external server.

11. The mobile terminal of claim 8, wherein the attribute comprises a first attribute comprising a category to which the first and the second item belong; and a second attribute comprising at least one of time at which the first and the second item have been created, a transmitter of the first and the second item, a receiver of the first and the second item, contents of the first and the second item, and titles of the first and the second item.

12. The mobile terminal of claim 11, wherein the controller, within a category whose first attribute is the same as the first attribute of the first item selected, searches for a second item whose second attribute is the same as that of the first item selected and displays the second item.

13. A method for controlling a mobile terminal, comprising:
displaying a first item;
receiving a selection signal for at least one of the first items; and
searching for and displaying at least one second item of the same attribute with the selected at least one first item.

14. The method of claim 13, wherein the receiving the selection signal comprises:
dragging the displayed first item;
dropping the dragged first item into a predetermined area; and
generating the selection signal in accordance with the first item dropped into the predetermined area.

15. The method of claim 13, wherein the first and the second item comprise at least one of an image, a video, an e-mail, a message, and a social network service message stored in any one of the mobile terminal, a different terminal, and an external server.

16. The method of claim 13, wherein the searching and displaying, among second items corresponding to the attribute of a category to which the first items belong, displays a second item corresponding to any one of time at which the first item has been created, a transmitter of the first item, a receiver of the first item, contents of the first item, and a title of the first item.
